(19) United States
(12) Patent Application Publication
(10) Pub. No.: US 2020/0156894 A1
(43) Pub. Date: May 21, 2020

(54) PAPER STACKING DEVICE AND IMAGE FORMING SYSTEM

(71) Applicant: KONICA MINOLTA, INC., Tokyo (JP)

(72) Inventor: Tsuyoshi TSUCHIYA, Tokyo (JP)

(73) Assignee: KONICA MINOLTA, INC., Tokyo (JP)

(21) Appl. No.: 16/682,496

(22) Filed: Nov. 13, 2019

(30) Foreign Application Priority Data
Nov. 21, 2018 (JP) 2018-218545

(51) Int. Cl. B65H 29/34; G03G 15/00

(52) U.S. Cl. CPC B65H 29/34; G03G 15/6529

(57) ABSTRACT

A paper stacking device includes: a stacker on which paper is stacked; a paper ejector that ejects the paper toward the stacker, and a paper floating member that supports, from below, a side end of the paper ejected from the paper ejector, wherein the paper floating member is switched between: a paper floating position that advances from a side of the side end of the paper to an ejection route of the paper, and causes the paper ejected from the paper ejector to float from uppermost paper stacked on the stacker, and a retreat position that retreats from the ejection route.

The entire disclosure of Japanese patent Application No. 2018-218545, filed on Nov. 21, 2018, is incorporated herein by reference in its entirety.

### BACKGROUND

### Technological Field

The present invention relates to a paper stacking device and an image forming system.

### Description of the Related Art

An image forming apparatus and a paper processing apparatus include a paper stacking device that stacks paper on which prescribed processing has been performed. The paper stacking device includes an ejected paper tray (a stacker) on which paper is stacked, and a paper ejecting roller (a paper ejector) that ejects paper toward the ejected paper tray. The paper ejected from the paper ejecting roller is sequentially staked on the ejected paper tray. Meanwhile, in this type of paper stacking device, paper ejected from a paper ejecting roller is stuck onto paper stacked on an ejected paper tray, and in particular, uppermost paper, in some cases. Therefore, in some cases, a front end of the ejected paper buckles, paper that has already been stacked is pushed out and drops from the ejected paper tray, or misalignment in a paper ejection direction occurs.

For example, JP 2014-40326 A, JP 2014-105081 A, and JP 2014-47047 A disclose a method for disposing a fan on an outer side in a paper width direction of paper and blowing air to side ends of the paper that are located on both sides in the paper width direction so as to suppress the sticking of paper. In addition, for example, JP 2011-84359 A discloses a configuration in which a holder is included that extends along a paper ejection direction and the holder is rotatable with a shaft member that extends in a paper width direction as a center. In JP 2011-84359 A, the holder can rotationally move upward to a first position in which the holder holds paper ejected from a paper ejecting roller, and can rotationally move downward from the first position to a second position in which the holder does not hold the paper.

However, the posture or behavior of paper ejected from a paper ejecting roller changes according to the basis weight of the paper, or the like. Therefore, techniques disclosed in JP 2014-40326 A, JP 2014-105081 A, and JP 2014-47047 A have a problem in which it is difficult to appropriately adjust air volume. For example, an excessively weak flow of air fails to cause paper to float. In contrast, an excessively strong flow of air raises paper, and the misalignment of paper occurs.

In addition, in a technique disclosed in JP 2011-84359 A, the holder is rotationally moved in upward and downward directions along the paper ejection direction, and therefore the following inconvenience occurs according to the length of the holder. For example, in a case where the holder is long, it takes longer time to retreat from the first position to the second position, and there is a possibility of a reduction in productivity. In contrast, in a case where the holder is short, a front-end side of paper having a large size in the paper ejection direction hangs down from the holder, and there is a possibility of the occurrence of sticking onto uppermost paper.

### SUMMARY

The present invention has been made in view of the circumstances described above, and it is an object of the present invention to provide a paper stacking device and an image forming system that are capable of stacking paper with satisfactory productivity while suppressing the sticking of ejected paper.

To achieve the abovementioned object, according to an aspect of the present invention, a paper stacking device reflecting one aspect of the present invention comprises: a stacker on which paper is stacked; a paper ejector that ejects the paper toward the stacker, and a paper floating member that supports, from below, a side end of the paper ejected from the paper ejector, wherein the paper floating member is switched between: a paper floating position that advances from a side of the side end of the paper to an ejection route of the paper, and causes the paper ejected from the paper ejector to float from uppermost paper stacked on the stacker, and a retreat position that retreats from the ejection mute.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram schematically illustrating an image forming system according to the present embodiment;

FIG. 2 is an explanatory diagram illustrating an enlarged view of a principal portion of a paper stacking device;

FIGS. 3A and 3B are diagrams explaining a configuration of a paper floating member;

FIGS. 4A and 4B are diagrams explaining a configuration of a paper floating member;

FIG. 5 is a flowchart illustrating an operation of a paper stacking device according to the present embodiment;

FIGS. 6A to 6C are explanatory diagrams exemplifying three paper floating positions; and

FIG. 7 is an explanatory diagram illustrating a relationship between information relating to paper and a paper floating position.

### DETAILED DESCRIPTION OF EMBODIMENTS

Hereinafter, one or more embodiments of the present invention will be described with reference to the drawings. However, the scope of the invention is not limited to the disclosed embodiments.

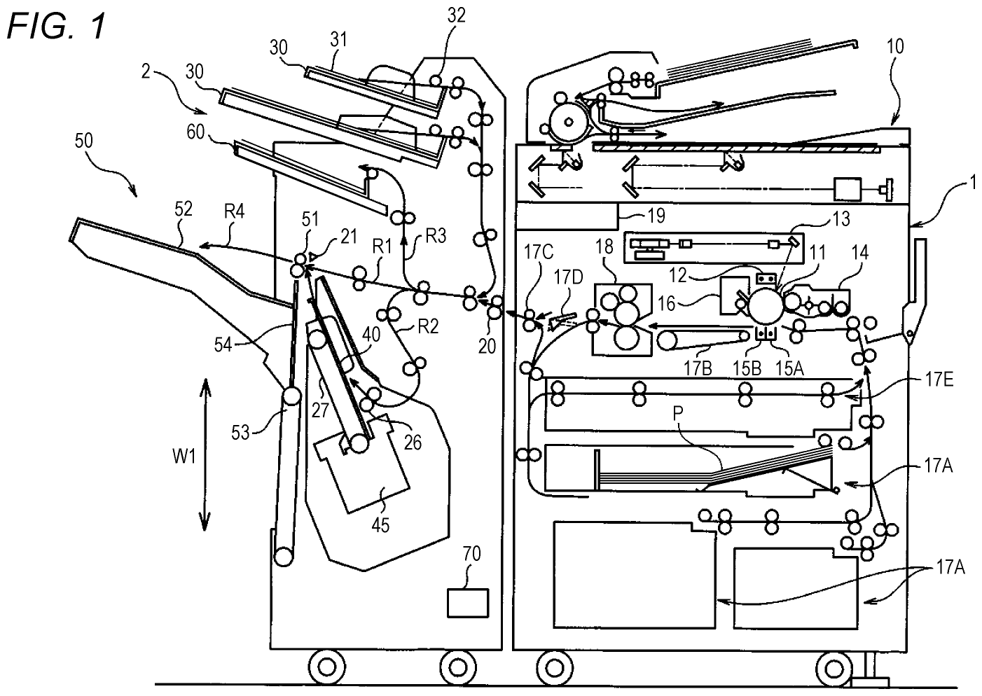

FIG. 1 is a configuration diagram schematically illustrating an image forming system according to the present embodiment. The image forming system according to the present embodiment includes an image forming apparatus 1 and a postprocessing apparatus 2.

The image forming apparatus 1 is an electrophotographic image forming system such as a copying machine, and the image forming apparatus 1 forms an image on paper P on the basis of image data. The image forming apparatus 1 includes an original reader 10, a photoreceptor 11, an electrifier 12, an image exposure unit 13, a developing unit 14, a transfer unit 15A, a separator 15B, a cleaning device 16, a fixing device 18, and an image formation controller 19.

The original reader 10 is disposed in an upper portion of a housing of the image forming apparatus 1, and includes an automatic original delivering unit that automatically moves an original in reading an image. This original reader 10 reads an image formed on the original, and outputs a prescribed image signal. A/D conversion is performed on the output image signal, so that image data is generated.

An image reading controller (not illustrated) included in the original reader 10 performs processing, such as shading correction, dither processing, or compression, on the image data, and outputs data obtained as a result of this processing as final image data to the image formation controller 19. The image formation controller 19 may obtain image data from the original reader 10, or may obtain image data from a personal computer that is connected to the image forming system, or another image forming system.

A surface of the photoreceptor 11 is uniformly electrified by the electrifier 12. The image exposure unit 13 scans and exposes the surface of the photoreceptor 11 to a laser beam on the basis of output information that has been output from the image formation controller 19 on the basis of the image data. By doing this, a latent image is formed on the surface of the photoreceptor 11. The developing unit 14 develops the latent image with toner, and forms an image (a toner image) on the surface of the photoreceptor 11.

Paper P stored in a paper tray 17A is fed to the transfer unit 15A. The transfer unit 15A transfers, onto the paper P, the image on the surface of the photoreceptor 11. The separator 15B separates the paper P onto which the image has been transferred from the photoreceptor 11. The cleaning device 16 removes toner that remains on the surface of the photoreceptor 11 after the image has been transferred onto the paper P. An intermediate conveyor 17B conveys the separated paper P to the fixing device 18.

The fixing device 18 performs fixing processing for fixing the image onto the paper P by heating and pressing. A first paper ejecting roller 17C ejects (feeds), to the postprocessing apparatus 2, the paper P on which fixing processing has been performed.

On the other hand, in a case where an image is formed on both sides of the paper P, a conveyance direction of the paper P on which fixing processing has been performed by the fixing device 18 is switched from a direction toward the first paper ejecting roller 17C to a downward direction (a direction toward a reverse conveyor 17E) by a conveyance route switching plate 17D. The reverse conveyor 17E switches back the paper P so as to reverse a front surface and a reverse surface of the paper P, and conveys the paper P to the transfer unit 15A.

The image formation controller 19 controls the image forming apparatus 1. As the image formation controller 19, a microcomputer that principally includes a CPU, a ROM, a RAM, and an I/O interface can be used. The CPU executes various programs (a processor). The ROM stores the various programs to be executed by the CPU in the form of a program code that can be read by the CPU. The ROM also stores data that is used to execute the programs. The RAM is a memory serving as a working storage area. When the programs and the data that have been stored in the ROM are read by the CPU, the programs and the data are developed on the RAM. Then, the CPU performs various types of processing on the basis of the programs and the data that have been developed on the RAM.

The postprocessing apparatus 2 is disposed on a downstream side of the image forming apparatus 1 in a paper conveyance direction so as to be adjacent to the image forming apparatus 1, and the postprocessing apparatus 2 is a paper processing apparatus that performs prescribed processing on paper P ejected from the image forming apparatus 1. In the present embodiment, the postprocessing apparatus 2 performs staple processing (binding processing), and stated another way, processing for superimposing plural sheets of paper P that have been ejected from the image forming apparatus 1 and binding the plural sheets of paper P by using a staple (a binding member). The postprocessing apparatus 2 principally includes an introducing unit 20, an intermediate stacker 40, a staple unit 45, a paper stacking device 50, and a paper processing controller 70.

The introducing unit 20 receives paper P ejected from the image forming apparatus 1, and delivers this paper P into the postprocessing apparatus 2. The position of the introducing unit 20 has been set to correspond to the position of the first paper ejecting roller 17C of the image forming apparatus 1.

In order to introduce, into the postprocessing apparatus 2, paper P other than paper P ejected from the image forming apparatus 1, the postprocessing apparatus 2 is provided with a paper feeding unit 30. The paper feeding unit 30 includes a paper feeding tray 31 and a paper delivering unit 32. Paper P placed on the paper feeding tray 31 is taken in by the paper delivering unit 32, and is conveyed through a prescribed conveyance route, and joins a conveyance route on a downstream side of the introducing unit 20.

The outline of a conveyance route of paper P in the postprocessing apparatus 2 is described. The conveyance route on the downstream side of the introducing unit 20 branches into a first conveyance route R1, a second conveyance route R2, and a third conveyance route R3. Paper P introduced from the introducing unit 20 or the paper feeding unit 30 is delivered to any of the conveyance routes R1 to R3 according to the switching of a switching gate (not illustrated). In a case where staple processing is not performed and paper P is ejected to a tray outside the apparatus, the switching gate is set to the first conveyance route R1 or the third conveyance route R3. In contrast, in a case where staple processing is performed, the switching gate is set to the second conveyance route R2.

The first conveyance route R1 is a route through which no processing is performed on introduced paper P and the introduced paper P is conveyed to the paper stacking device 50 with no change. On the first conveyance route R1, a conveyance roller that conveys paper P, and the like are disposed.

The second conveyance route R2 is a route through which introduced paper P is conveyed to the paper stacking device 50 via the intermediate stacker 40. On the second conveyance route R2, a conveyance roller that conveys paper P, a stacker paper ejecting roller 26, a conveyance belt 27, and the like are disposed.

The stacker paper ejecting roller 26 is disposed in a position facing a paper placement surface of the intermediate stacker 40, and the stacker paper ejecting roller 26 ejects, to the intermediate stacker 40, paper P that has been conveyed through the second conveyance route R2. The conveyance belt 27 conveys, to the paper stacking device 50, a paper bundle placed on the intermediate stacker 40, and stated another way, plural sheets of paper P that have been bound with a staple.

The intermediate stacker 40 sequentially stacks paper P ejected from the stacker paper ejecting roller 26 such that staple processing will be performed by the staple unit 45. The intermediate stacker 40 is disposed in such a way that a front end of paper P placed on the intermediate stacker 40 faces more upward than a rear end of the paper P. When the paper P ejected from the stacker paper ejecting roller 26 drops onto the intermediate stacker 40, the paper P slides down on the intermediate stacker 40, and stops by the rear end of the paper P abutting onto a rear-end guide plate (not illustrated).

The staple unit 45 includes a stapler that drives a staple, and a clincher that clinches a tip of the staple along paper P. This staple unit 45 performs staple processing on plural sheets of paper P stacked on the intermediate stacker 40 by stapling the plural sheets of paper P in a predetermined position and a predetermined orientation. For example, the staple unit 45 performs side stitching for stapling a rear end of paper P.

The third conveyance route R3 is a route through which introduced paper P is conveyed to a sub tray 60. On the third conveyance route R3, a conveyance roller that conveys paper P is disposed. The sub tray 60 is disposed in an upper portion outside the apparatus. A small number of sheets of paper can be stacked on the sub tray 60, and therefore the sub tray 60 is used in the ejection of a small number of sheets of special paper P such as thick paper.

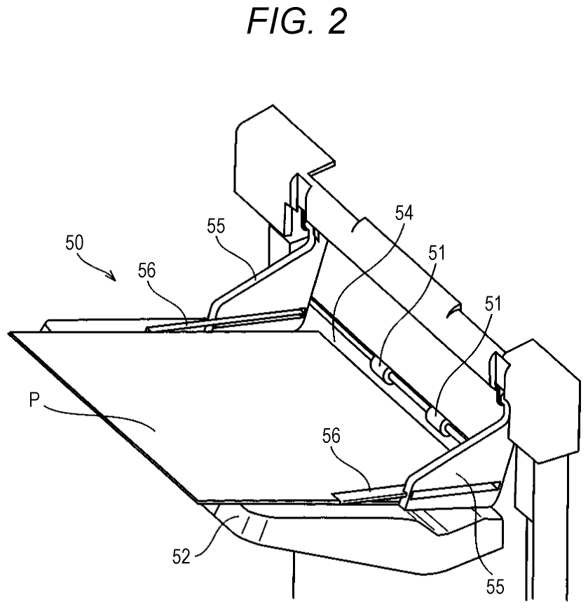

FIG. 2 is an explanatory diagram illustrating an enlarged view of a principal portion of the paper stacking device 50. The paper stacking device 50 is a device that ejects and stacks paper P conveyed inside the postprocessing apparatus 2. The paper stacking device 50 principally includes a second paper ejecting roller 51, an ejected paper tray 52, an elevating/lowering mechanism 53 (see FIG. 1), a bumper plate 54, side-end aligning plates 55, and paper floating members 56.

The second paper ejecting roller 51 is located at the ends of the first conveyance route R1 and the second conveyance route R2, and ejects, toward the ejected paper tray 52, paper P conveyed through the respective conveyance routes R1 and R2. Herein, a front end and a rear end of paper P in the paper stacking device 50 are defiled by using, as a reference, a paper ejection direction at the time of ejection from the second paper ejecting roller 51.

The ejected paper tray 52 is a tray on which paper P ejected from the second paper ejecting roller 51 is stacked. The ejected paper tray 52 can be elevated or lowered along a paper stacking direction (upward and downward directions) W1 by the elevating/lowering mechanism 53. The elevating/lowering mechanism 53 is controlled by the paper processing controller 70 in such a way that uppermost paper P stacked on the ejected paper tray 52 maintains a prescribed height.

The ejected paper tray 52 has an inclined shape in such a way that a side of a front end of paper P stacked on the ejected paper tray 52 faces more upward than a side of a rear end of the paper P. The bumper plate 54 having a vertical wall shape is provided on the side of the rear end of the paper P in the ejected paper tray 52. This bumper plate 54 has a function of aligning paper P stacked on the ejected paper tray 52 by a rear end of the paper P bumping the bumper plate 54.

The side-end aligning plates 55 are provided on the ejected paper tray 52, and are members that align side ends of paper P that are located on both sides in a paper width direction (a direction orthogonal to the paper ejection direction). The side-end aligning plates 55 are respectively disposed on both sides in the paper width direction with paper P ejected from the second paper ejecting roller 51 as a center. Stated another way, an ejection route R4 (see FIG. 1) of paper P ejected from the second paper ejecting roller 51 is located between a pair of side-end aligning plates 55. Each of the pair of side-end aligning plates 55 is connected to a power mechanism (not illustrated) such as an electric motor or a gear, and receives power from the power mechanism so as to be able to swing along the paper width direction. The positions of the pair of side-end aligning plates 55 are set according to the width (size) of paper P ejected from the second paper ejecting roller 51, and the pair of side-end aligning plates 55 is disposed on sides of paper P that is ejected from the second paper ejecting roller 51 and is stacked on the ejected paper tray 52. When paper P ejected from the second paper ejecting roller 51 is stacked on the ejected paper tray 52, the pair of side-end aligning plates 55 moves in the paper width direction and sandwiches the paper P from both sides so as to align side ends of the paper P (a paper alignment operation). The operation of the pair of side-end aligning plates 55 is controlled by the paper processing controller 70.

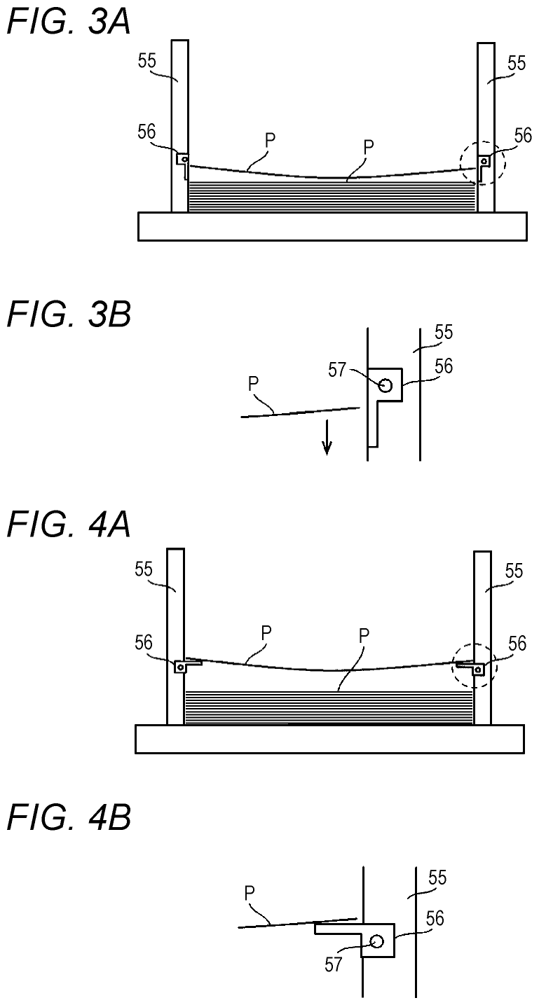

FIGS. 3A and 3B and FIGS. 4A and 4B are diagrams explaining a configuration of the paper floating member 56. FIG. 3B and FIG. 4B are diagrams that respectively illustrate enlarged views of areas surrounded with a broken line in FIG. 3A and FIG. 4A. The paper floating member 56 is a member that supports, from below, a side end of paper P ejected from the second paper ejecting roller 51. The paper floating member 56 includes a plate shape member that extends along the paper ejection direction. In the present embodiment, the paper floating members 56 are respectively provided on sides of paper P, and specifically, in the pair of the side-end aligning plates 55. Stated another way, a pair of paper floating members 56 can respectively support, from below, both side ends of paper P ejected from the second paper ejecting roller 51.

An individual paper floating member 56 is coupled to a shaft member 57 that extends in the paper ejection direction, and can rotationally move with this shaft member 57 as a center.

The individual paper floating member 56 is connected to a power mechanism (not illustrated) such as a solenoid or a link mechanism. The individual paper floating member 56 receives power from the power mechanism, and rotationally moves with the shaft member 57 as a center. The individual paper floating member 56 rotationally moves with the shaft member 57 as a center so as to be able to move between a retreat position and a paper floating position. Switching between the retreat position and the paper floating position is controlled by the paper processing controller 70.

The retreat position is a position that retreats from the ejection route R4 of paper P and does not interfere with paper P ejected from the second paper ejecting roller 51. An example of the retreat position is a state where the paper floating member 56 is housed along the side-end aligning plate 55 so as to be almost flush with the side-end aligning plate 55, as illustrated in FIGS. 3A and 3B. In addition, this retreat position is equivalent to a home position of the paper floating member 56.

The paper floating position is a position that advances to the ejection route R4 of paper P and causes paper P ejected from the second paper ejecting roller 51 to float from uppermost paper P stacked on the ejected paper tray 52. An example of the paper floating position is a state where the paper floating member 56 has risen from the retreat position so as to be approximately perpendicular to the side-end aligning plate 55, as illustrated in FIGS. 4A and 4B.

The paper processing controller 70 performs control relating to the postprocessing apparatus 2. As the paper processing controller 70, a microcomputer that principally includes a CPU, a ROM, a RAM, and an I/O interface can be used. The CPU executes various programs (a processor). The ROM stores the various programs to be executed by the CPU in the form of a program code that can be read by the CPU. The ROM also stores data that is used to execute the programs. The RAM is a memory serving as a working storage area. When the programs and the data that have been stored in the ROM are read by the CPU, the programs and the data are developed on the RAM. Then, the CPU performs various types of processing on the basis of the programs and the data that have been developed on the RAM.

In a relationship with the present embodiment, the paper processing controller 70 controls an operation of the paper floating members 56 and specifically, a paper floating operation. The paper floating operation is a series of operations to displace the paper floating members 56 from the retreat position to the paper floating position and then, to return the paper floating members 56 from the paper floating position to the retreat position. The paper floating operation is performed according to a timing at which paper P is ejected from the second paper ejecting roller 51.

On the conveyance route of paper P, a paper ejection sensor 21 is disposed that detects a tinting at which paper P is ejected by the second paper ejecting roller 51. For example, the paper ejection sensor 21 is disposed near the second paper ejecting roller 51 on the conveyance route of paper P. As the paper ejection sensor 21, a photosensor or the like that is switched between ON and OFF according to the presence/absence of paper P can be used. Specifically, the paper ejection sensor 21 outputs ON while paper P is passing through the paper ejection sensor 21, and the paper ejection sensor 21 outputs OFF in the case of the absence of paper P. A detection result of the paper ejection sensor 21 is output to the paper processing controller 70.

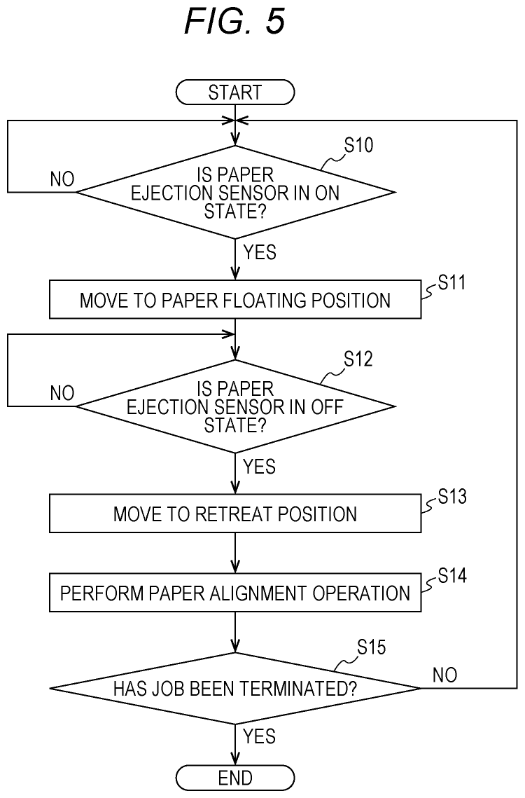

FIG. 5 is a flowchart illustrating an operation of the paper stacking device 50 according to the present embodiment. Processing illustrated in this flowchart is performed by the paper processing controller 70 by using the execution of a job as a trigger. Before the execution of a jog, the paper floating members 56 have been set to be located in the retreat position serving as a home position.

First, in step S10, the paper processing controller 70 refers to the paper ejection sensor 21, and determines whether the paper ejection sensor 21 is in an ON state. When a front end of paper P reaches the second paper ejecting roller 51, an output of the paper ejection sensor 21 is switched to ON. Accordingly, a timing at which the ejection of paper P from the second paper ejecting roller 51 is started can be determined on the basis of the state of the paper ejection sensor 21. In a case where the paper ejection sensor 21 is in the ON state, and stated another way, in a case where the ejection of paper P from the second paper ejecting roller 51 is started, the determination of step S10 is affirmative, and the processing moves on to step S11. In contrast, in a case where the paper ejection sensor 21 is in an OFF state, and stated another way, in a case where paper P is not ejected from the second paper ejecting roller 51, the determination of step S10 is negative, and the processing returns to step S10.

In step S11, the paper processing controller 70 moves the paper floating members 56 from the retreat position to the paper floating position. When the paper floating members 56 move to the paper floating position, both side ends of paper P ejected from the second paper ejecting roller 51 are respectively supported by the pair of paper floating members 56. Therefore, the paper P is ejected in a state where the paper P is floating from uppermost paper P stacked on the ejected paper tray 52.

In step S12, the paper processing controller 70 refers to the paper ejection sensor 21, and determines whether the paper ejection sensor 21 is in the OFF state. When a rear end of paper P passes through the second paper ejecting roller 51, an output of the paper ejection sensor 21 is switched to OFF. Accordingly, a timing at which the ejection of paper P from the second paper ejecting roller 51 has been terminated can be determined on the basis of the state of the paper ejection sensor 21. In a case where the paper ejection sensor 21 is in the OFF state, and stated another way, in a case where the ejection of paper P from the second paper ejecting roller 51 has been terminated, the determination of step S12 is affirmative, and the processing moves on to step S13. In contrast, in a case where the paper ejection sensor 21 is in the ON state, and stated another way, in a case where paper P continues being ejected from the second paper ejecting roller 51, the determination of step S12 is negative, and the processing returns to step S12.

In step S13, the paper processing controller 70 moves (returns) the paper floating members 56 from the paper floating position to the retreat position. When the paper floating members 56 move to the retreat position, the paper floating members 56 retreat from the ejection route R4 of paper P ejected from the second paper ejecting roller 51. Therefore, the paper P drops due to its own weight, and is stacked as uppermost paper P on the ejected paper tray 52.

In step S14, the paper processing controller 70 causes the side-end aligning plates 55 to operate, and performs a paper alignment operation.

In step S15, the paper processing controller 70 determines whether paper P ejected from the second paper ejecting roller 51 is absent, and stated another way, whether the jog has been terminated. In a case where the job has not been terminated and there is paper P ejected from the second paper ejecting roller 51, the determination of step S15 is negative, and the processing returns to step S10. In contrast, in a case where the job has been terminated and there is no paper P ejected from the second paper ejecting roller 51, the determination of step S15 is affirmative, and this routine is terminated.

As described above, in the present embodiment, the paper stacking device 50 includes: the ejected paper tray 52 on which paper P is stacked; the second paper ejecting roller 51 that ejects paper P toward the ejected paper tray 52; and the paper floating members 56 that support, from below, side ends of paper P ejected from the second paper ejecting roller 51. In this case, the paper floating members 56 can be switched between the paper floating position and the retreat position. The paper floating position is a position that advances from a side of the side ends of paper P to the ejection route R4 of the paper P and causes paper P ejected from the second paper ejecting roller 51 to float from uppermost paper P stacked on the ejected paper tray 52. The retreat position is a position that retreats from the ejection route R4 of the paper P.

By employing this configuration, the paper floating members 56 are set to be located in the paper floating position, and therefore the side ends of paper P are supported from below by the paper floating members 56. This enables the paper P to be ejected while the paper P is floating. This can suppress the occurrence of sticking onto uppermost paper P. In addition, the side ends of paper P are supported from sides of the paper P, and therefore the paper floating members 56 do not need to be set to have a large size in the paper width direction. This does not cause a reduction in productivity. In addition, the paper floating members 56 can secure a sufficient length in the paper ejection direction, and this can appropriately suppress sticking onto uppermost paper P.

Further, in the present embodiment, the paper stacking device 50 further includes the pair of side-end aligning plates 55 that sandwiches paper P stacked on the ejected paper tray 52 from both sides so as to align side ends of the paper P. The paper floating members 56 are respectively disposed inside the pair of side-end aligning plates 55.

By employing this configuration, the paper floating members 56 are appropriately disposed on sides of paper P according to the positions of the pair of side-end aligning plates 55, and therefore the side ends of the paper P can be easily supported. This can suppress sticking onto uppermost paper P without a reduction in productivity.

Furthermore, in the present embodiment, the paper floating members 56 perform a paper floating operation of displacing from the retreat position to the paper floating position and then, returning from the paper floating position to the retreat position, according to a timing at which paper P is ejected from the second paper ejecting roller 51.

By employing this configuration, the paper floating members 56 can be caused to operate in accordance with a timing of the ejection of paper P. This enables paper P to float or drop onto the ejected paper tray 52 at an appropriate timing. As a result, the sticking of paper P can be suppressed, and a reduction in productivity can also be suppressed.

In addition, in the present embodiment, the paper stacking device 50 further includes the paper processing controller 70 that controls an operation of the paper floating members 56.

By employing this configuration, the paper floating members 56 can be controlled with an appropriate timing by using the paper processing controller 70.

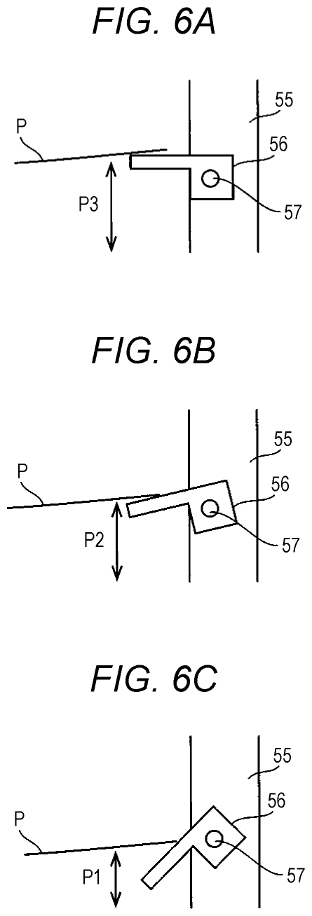

The present embodiment has been described under the assumption that the paper floating member 56 can select one paper floating position. However, the paper floating member 56 may have a plurality of paper floating positions that are different in an amount of floating from uppermost paper P stacked on the ejected paper tray 52. Here, FIGS. 6A to 6C are explanatory diagrams exemplifying three paper floating positions P1 to P3 as the plurality of paper floating positions. The paper floating position P3 is a position that has the largest amount of floating of paper P, and the paper floating position P1 is a position that has the smallest amount of floating of paper P. In addition, the paper floating position P2 is a position that has an amount of floating of paper P that is intermediate between the amounts of floating of the paper floating position P3 and the paper floating position P1.

In this case, it is preferable that the paper processing controller 70 switch the three paper floating positions P1 to P3 on the basis of information relating to paper P to be ejected from the second paper ejecting roller 51. Here, examples of the information relating to paper P include the basis weight of paper P, the size of paper P, and image information printed on paper P.

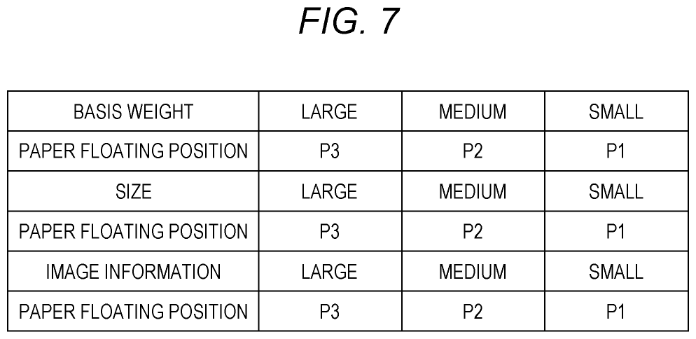

FIG. 7 is an explanatory diagram illustrating a relationship between information relating to paper P and a paper floating position. The basis weight of paper P is handled below at three levels, large, medium, and small. In a case where paper P has a large basis weight, the paper P tends to be easily deflected due to its own weight. Therefore, sticking onto uppermost paper P easily occurs. On the other hand, in a case where paper P has a large basis weight, the paper P has a high dropping speed. Therefore, even if the paper floating position P3 is selected, a reduction in productivity is small. Accordingly, in a case where paper P has a large basis weight, the paper floating position P3 is used.

In contrast, in a case where paper P has a small basis weight, the paper P has a slow dropping speed. However, in a case where paper P has a small basis weight, the deflection of the paper P is small. Therefore, even if the paper floating position P1 is selected, an influence of sticking onto uppermost paper P is small. Accordingly, in a case where paper P has a small basis weight, the paper floating position P1 is used. In a case where paper P has a medium basis weight, the paper floating position P2 is used in consideration of both the sticking of paper P and productivity.

A similar manner of thinking is applied to the size of paper P and image information printed on paper P. Stated another way, in a case where paper P has a large size, the paper floating position P3 is used. In a case where paper P has a medium size, the paper floating position P2 is used. In a case where paper P has a small size, the paper floating position P1 is used. In addition, in a case where paper P has a large amount of image information, the paper floating position P3 is used. In a case where paper P has a medium amount of image information, the paper floating position P2 is used. In a case where paper P has a small amount of image information the paper floating position P1 is selected.

Further, instead of switching the paper floating position in multiple stages, the paper processing controller 70 may determine whether to perform a paper floating operation on the basis of information relating to paper P to be ejected from the second paper ejecting roller 51.

Furthermore, in the present embodiment, a method for switching the paper floating position and the retreat position by rotationally moving the paper floating members 56 has been described. However, an operation mode of the paper floating member 56 is not limited to this. For example, the paper floating members 56 may retreat in a horizontal direction so that the paper floating position and the retreat position are switched.

In addition, in the present embodiment, the paper floating member 56 is provided in the side-end aligning plate 55. However, the paper floating member 56 may be provided separately from the side-end aligning plate 55. However, by providing the paper floating member 56 in the side-end aligning plate 55, the side-end aligning plate 55 is set in a position according to the size of paper P. Therefore, an effect can be exhibited by which the paper floating member 56 can also be disposed automatically in a side end of the paper P.

An image forming system and a paper stacking device according to an embodiment of the present invention have been described above. However, the present invention is not limited to the embodiment described above, and a variety of variations can be made without departing from the scope of the invention.

For example, in the present embodiment, the image forming system includes an image forming apparatus that has an image forming function and a paper processing apparatus that performs processing on paper. However, the paper stacking device may be applied to an isolated paper processing apparatus that is independent of the image forming system, or the paper stacking device may be applied to an isolated image forming apparatus that is independent of the image forming system.

In addition, in the present embodiment, the paper processing apparatus includes a dedicated controller, and the controller controls the paper stacking device. However, the paper stacking device may include a dedicated controller. Further, in a case where the paper processing apparatus is combined with the image forming apparatus, a controller that controls the image forming apparatus may control the paper stacking device.

Although embodiments of the present invention have been described and illustrated in detail, the disclosed embodiments are made for purposes of illustration and example only and not limitation. The scope of the present invention should be interpreted by terms of the appended claims.

What is claimed is:

1. A paper stacking device comprising:
a stacker on which paper is stacked;
a paper ejector that ejects the paper toward the stacker; and
a paper floating member that supports, from below, a side end of the paper ejected from the paper ejector,
wherein the paper floating member is switched between:
a paper floating position that advances from a side of the side end of the paper to an ejection route of the paper, and causes the paper ejected from the paper ejector to float from uppermost paper stacked on the stacker, and
a retreat position that retreats from the ejection route.

2. The paper stacking device according to claim 1, further comprising
a pair of aligning plates that aligns a plurality of the side ends of the paper by sandwiching the paper stacked on the stacker from both sides,
wherein the paper floating member is disposed inside each of the pair of aligning plates.

3. The paper stacking device according to claim 1,
wherein the paper floating member
performs a paper floating operation of displacing from the retreat position to the paper floating position and then, returning from the paper floating position to the retreat position, according to a timing at which the paper is ejected from the paper ejector.

4. The paper stacking device according to claim 3, further comprising
a hardware processor that controls an operation of the paper floating member.

5. The paper stacking device according to claim 4,
wherein the paper floating member
has a plurality of paper floating positions that are different in an amount of floating from the uppermost paper stacked on the stacker, and
the hardware processor switches the plurality of paper floating positions on the basis of information relating to the paper to be ejected from the paper ejector.

6. The paper stacking device according to claim 4,
wherein the hardware processor determines whether to perform the paper floating operation on the basis of information relating to the paper to be ejected from the paper ejector.

7. An image forming system comprising:
an image forming apparatus that forms an image on paper, and
a paper processing apparatus that performs processing on the paper that has been fed from the image forming apparatus,
wherein the paper processing apparatus includes the paper stacking device according to claim 1 to which the paper on which the processing has been performed is ejected.
